(19) United States
(12) Patent Application Publication
(10) Pub. No.: US 2026/0225225 A1
(43) Pub. Date: Aug. 6, 2026

(54) SYSTEMS AND METHODS OF MULTI-CATEGORY MOVER DEVICE COORDINATION

(71) Applicant: ROCKWELL AUTOMATION TECHNOLOGIES, INC., Mayfield Heights, OH (US)

(72) Inventors: Anthony J. Diblasio, Independence, OH (US); Bhanu K. Gouda, Reminderville, OH (US); Keith D. Carter, Locust, NC (US)

(73) Assignee: ROCKWELL AUTOMATION TECHNOLOGIES, INC., Mayfield Heights, OH (US)

(21) Appl. No.: 19/044,027

(22) Filed: Feb. 3, 2025

(51) Int. Cl. B25J 5/00; B25J 9/16

(52) U.S. Cl. CPC B25J 5/005; B25J 9/162; B25J 9/1661

(57) ABSTRACT

Systems and methods to control multiple categories of movers in a track-based environment. The system includes or more processors coupled with memory. The processors obtain first data that can indicate a first characteristic of a first mover of a first category of movers. The processors obtain second data that can indicate a second characteristic of a second mover of a second category of movers. The processors determine a task that includes a first action and a second action. The processors determine that the first mover can perform the first action and that the second mover can perform the second action. The processors generate a data structure to cause the first and second movers to perform the first and second actions. The processors provide a first portion of data structure to the first mover and a second portion of the data structure to the second mover, to perform the task.

### BACKGROUND

Robotic devices can travel from one location to another location as part of their activity.

### SUMMARY

At least one aspect is directed to a system to control multiple categories of movers in a track-based environment. The system can include one or more processors coupled with memory. The one or more processors can obtain, from a database, first data. The first data can indicate a first characteristic of a first mover of a first category of movers. The one or more processors can obtain second data. The second data can indicate a second characteristic of a second mover of a second category of movers. The one or more processors can determine a task. The task can include a first action associated with the first mover and a second action associated with the second mover. The one or more processors can determine, based on the first characteristic, that the first mover is configured to perform the first action. The one or more processors can determine, based on the second characteristic, that the second mover is configured to perform the second action. The one or more processors can generate at least one data structure to cause the first mover to perform the first action and to cause the second mover to perform the second action. The one or more processors can provide a first portion of the at least one data structure to the first mover to execute the first action and provide a second portion of the at least one data structure to the second mover to execute the second action to cause the first mover and the second mover to perform the task.

At least one aspect is directed to a method of controlling multiple categories in a track-based environment. The method can comprise obtaining, by one or more processors coupled with memory, from a database, first data. The first data can indicate a first characteristic of a first mover of a first category of movers. The method can comprise obtaining, by the one or more processors, second data. The second data can indicate a second characteristic of a second mover of a second category of movers. The method can comprise determining, by the one or more processors, a task. The task can include a first action associated with the first mover and a second action associated with the second mover. The method can comprise determining, by the one or more processors, based on the first characteristic, that the first mover is configured to perform the first action. The method can comprise determining, by the one or more processors, based on the second characteristic, that the second mover is configured to perform the second action. The method can comprise generating, by the one or more processors, at least one data structure. The at least one data structure can cause the first mover to perform the first action. The at least one data structure can cause the second mover to perform the second action. The method can comprise providing, by the one or more processors, a first portion of the at least one data structure to the first mover to execute the first action and provide a second portion of the at least one data structure to the second mover to execute the second action, to cause the first mover and the second mover to perform the task.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 depicts an example system to control multiple categories of movers in a track-based environment.

FIG. 2 depicts an example system to control multiple categories of movers in a track-based environment.

FIG. 3 depicts an example system to control multiple categories of movers in a track-based environment.

FIG. 4 depicts an example method of controlling multiple categories of movers in a track-based environment.

FIG. 5 depicts an example schematic block diagram of a computing system.

### DETAILED DESCRIPTION

Following below are more detailed descriptions of various concepts related to, and implementations of, multi-category mover device coordination. Before turning to the figures, which illustrate certain exemplary embodiments in detail, it should be understood that the present disclosure is not limited to the details or methodology set forth in the description or illustrated in the figures. The various concepts introduced above and discussed in greater detail below can be implemented in any of numerous ways. It should also be understood that the terminology used herein is for the purpose of description only and should not be regarded as limiting.

In a warehouse or another industrial environment, there can be a need to interact with one or more loads. For example, loads can be sorted, allocated, or moved from a first location to a second location. Multiple movers may be implemented to perform load operations. These movers can carry payload of various weights, move around tracks at different speeds, move near a track at different speeds, travel around different configurations of tracks, and operate in different operating environments. The movers can also be of multiple categories and operate through various control systems. Therefore, the different configurations and controlling mechanisms of each mover make it difficult to integrate movers of different types and ensure that the movers can perform a desired operation.

Coordination of movers in an industrial environment can be a difficult task. Multiple types of movers exist in the environment, and each utilize a different control scheme. For example, one type of mover in the environment may be remote controlled while another type of mover in the environment may be computer centralized. Therefore, each mover must be programmed in separate ways for the movers to perform a single task. Additionally, one type of mover is programmed separately and cannot communicate with another type of mover. This programming method can compromise efficiency of operations and increase the likelihood of an operation being performed incorrectly.

To overcome these and other challenges, the technical solutions of the present disclosure implement advanced features such as controlling various categories of movers in a track-based environment to perform a task in a unified control system. By employing a unified control system to control multiple types of movers, the system enables communication between multiple types of movers and minimizes the effort of controlling the movers, thereby optimizing track operation, production schedules, and enhancing track operations.

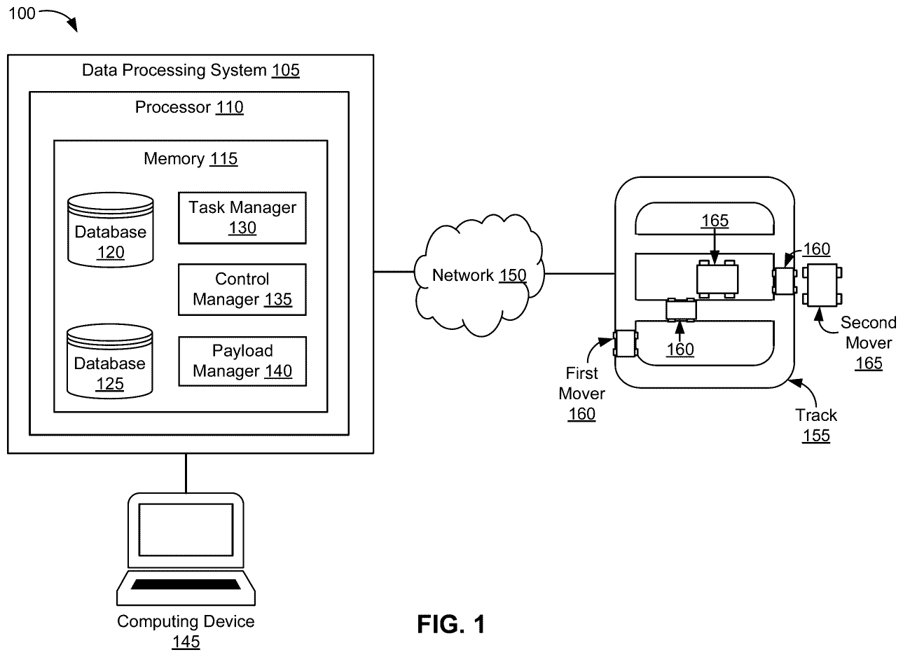

FIG. 1 depicts an example system 100 to control categories of movers in a track-based environment. For example, the system 100 can include at least one first mover 160, at least one second mover 165, and at least one track 155.

The system 100 can include a track-based environment. The track-based environment can include at least one track 155. The track 155 can include one or more first movers 160. For example, the track 155 can include a conveyance system, a pathway dedicated for a first mover 160, a structure consisting of a pair of parallel lines of rails, or a dedicated pathway. The track 155 can include raised walls, barriers along the edge of the pathway, or intersections with other parts of a track 155. The track 155 can include a central runner to guide the first mover 160 along the track, a smooth surface, magnetic rails, or a magnetic surface. The track 155 can include an independent cart technology (ICT) track. For example, the track 155 can include one or more first movers 160, wherein the one or more first movers 160 are ICT movers. The track-based environment can include one or more second movers 165. For example, the second movers 165 can be used next to or nearby the track 155. Additionally, some second movers 165 can be controlled to be used on the track 155.

The system 100 can include one or more processors 110 coupled with memory 115. Processor 110 can include any combination of hardware or software for processing instructions, such as instructions for providing functionalities of the data processing system 105 or data, such as the data of memory 115, database 120, database 125, task manager 130, control manager 135, payload manager 140, computing device 145, network 150, track 155, first mover 160, or second mover 165. For example, the processor 110 can receive input data or instructions from a computing device 145. The processor 110 can include a processor located in a mover motor. The processor 110 can be located in a programmable logic controller (PLC), a high-level controller (HLC), or a controller within a first mover 160 or a second mover 165. The processors 110 can include mobile processors, sever processors, embedded processors (such as microcontrollers), multi-core processors (including both single-core and multi-core variants), high-performance processors, ARM processors, x86 processors, quantum processors, FPGA-based processors, graphics processing units (GPUs), digital signal processors (DSPs), artificial intelligence (AI) processors (such as neural processing units (NPUs) and tensor processing units (TPUs)), superscalar processors, 64-bit processors, hyper-threaded processors, or system-on-chip (SoC) processors. The processor 110 may be located within a warehouse on a centralized controller or on a computing device 145 (e.g., mobile device, laptop, PC, etc.).

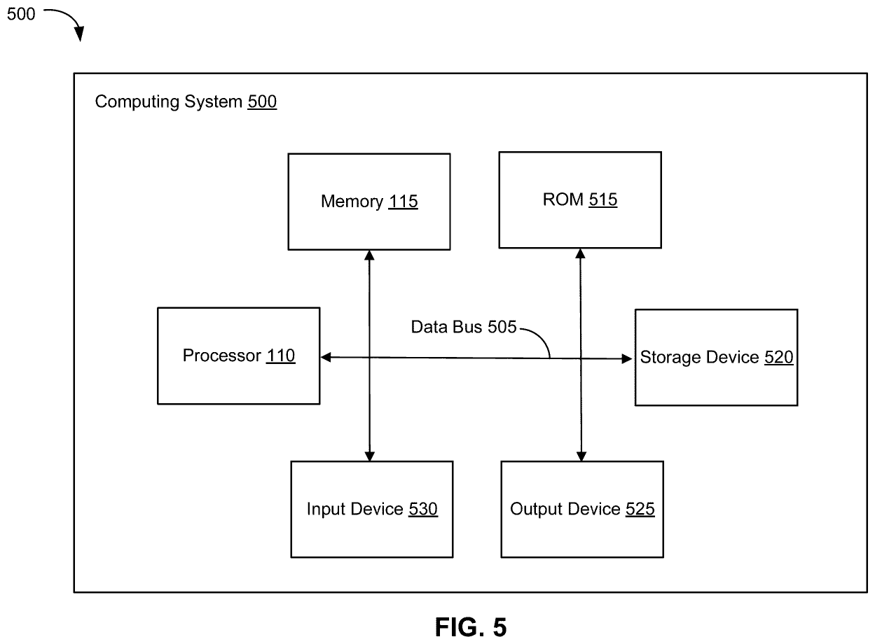

The at least one data processing system 105 can include one or more processor(s) 110 coupled with memory 115. The memory 115 can include RAM or ROM. The data processing system 105 can be located in a programmable logic controller (PLC), a high-level controller (HLC), or a controller within a first mover 160 or a second mover 165. The processors 110 can provide memory to storage device 520 (e.g., of FIG. 5 among others) or retrieve memory story to obtain data regarding the first mover 160 or the second mover 165.

Components of the system 100 such as the data processing system 105 that includes the processor 110, memory 115, and database 120 can obtain first data. For example, the first data can indicate a first characteristic of the first mover 160. The first mover 160 can be of a first category of movers. The first category of movers can include a plurality of track-based movers. For example, the first category of movers can include independent cart technology (ICT)-based movers, conveyer-based movers, linear motor movers, independent cart technology (ICT)-based movers using linear synchronous motor (LSM) technology, or any other track-based movers. The first characteristic can include at least one of a load capacity, a dimension, a velocity, an acceleration, a deceleration, a vibration, a curve section, an operation temperature, an operating environment (e.g., in air or under water), a track mileage, a duty cycle, a track geometry, a weight, a horsepower, a safety feature, a state of health, a payload, a machine-readable identifier, or an identifier of the first mover 160. The velocity characteristic can include a velocity of between 2 and 20 meters per second, (e.g., 10 m/s) as well as other velocities less than or greater than this range. The weight characteristic can be between 0.5 and 500 lbs. as well as other weights greater or less than this range. The operation temperature characteristic can include 150 degrees Fahrenheit as well as other temperatures greater or less than 150 degrees Fahrenheit. The track geometry characteristic can indicate compatibility with at least one of a circular track, a curved track, a straight track, etc. The machine-readable identifier characteristic can be at least one of a QR code, a barcode, a data matrix code, a Radio Frequency Identification (RFID) tag, a Near Field Communication (NFC) tag, an AR marker, or a color code. In tasks that include the use of an industrial robot or a robot manipulator (e.g., a robotic arm), the first data can include a characteristic of the industrial robot. For example, the characteristic of the industrial robot can include a load capacity, a dimension, a speed, an operation temperature, a weight, a state of health, an identifier, or any other characteristic. The processor 110 can receive the first data from memory 115, database 120, database 125, computing device 145, or be provided directly to the processor 110.

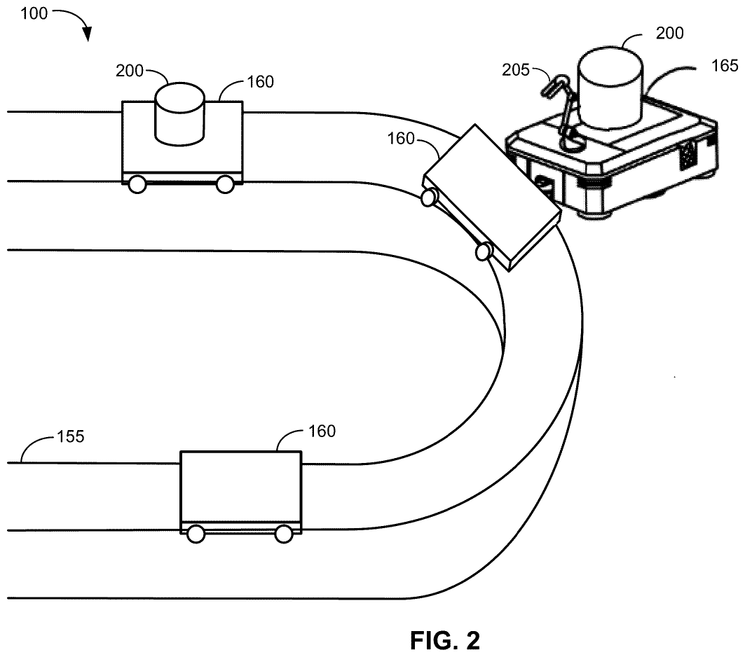

Components of the system 100 such as the data processing system 105 that includes the processor 110 and the memory 115 can obtain second data. For example, the second data can indicate a second characteristic of the second mover 165. The second mover 165 can be of a second category of movers. For example, the second category of movers can include autonomous mobile robots (AMR), automated guided vehicles (AGV), automated guided vehicles (AGV) using linear synchronous motor (LSM) technology, or any other non-track-based movers. The second characteristic can include at least one of a load capacity, a dimension, a velocity, an acceleration, a deceleration, a vibration, a horsepower, a safety feature, a weight, an operating temperature, an operation environment (e.g., in air or under water), a duty cycle, a state of health, a payload, a machine-readable identifier, or an identifier of the second mover 165. The velocity characteristic can include a velocity of between 2 and 20 meters per second, (e.g., 10 m/s) as well as other velocities less than or greater than this range. The weight characteristic can be between 0.5 and 500 lbs. as well as other weights greater or less than this range. The operation temperature characteristic can include 150 degrees Fahrenheit as well as other temperatures greater or less than 150 degrees Fahrenheit. The machine-readable identifier characteristic can be at least one of a QR code, a barcode, a data matrix code, a Radio Frequency Identification (RFID) tag, a Near Field Communication (NFC) tag, an AR marker, or a color code. In tasks that include an industrial robot or a robot manipulator (e.g., a robotic arm), the second data can include a characteristic of the industrial robot. For example, a robotic arm 205 can be fixed on the second mover, shown in FIG. 2, and assist with the task. The characteristic of the robotic arm can then include kinematics characteristics (e.g., link lengths, tool data, etc.), a state of health, an identifier, a weight, a dimension, or any other characteristic. The characteristic of the industrial robot can help the system 100, such as the task manager 130, determine that the task can be performed. For example, the dimensions of a robotic arm that is fixed on the second mover 165 can be used for collision prevention planning between the first mover 160 and the second mover 165. The processor 110 can receive the second data from memory 115, database 120, database 125, computing device 145, or be provided directly to the processor 110.

Components of the system 100, such as the task manager 130 within the data processing system 105, can determine a task. For example, the task can include a first action associated with the first mover 160 and a second action associated with the second mover 165. The task can be a load transfer operation, an assembly line operation, a sortation operation, or an allocation operation, among others. The first action or the second action can include at least one of a load transfer action, a speed action, an acceleration action, a deceleration action, an unload action, a load adjustment action, a queueing action, an obstacle avoidance action, or a lift action, among others. The task manager 130 can determine the task using one or more components of the system 100 (e.g., processor 110, memory 115, computing device 145, track 155, etc.) or be determined directly by the task manager 130.

Components of the system 100, such as the task manager 130, can determine that the first mover 160 is configured to perform the first action. For example, the task manager 130 can determine that the first mover 160 is configured to perform the first action based on the first characteristic. For example, the task manager 130 can receive data from at least one of the database 120, the database 125, or another component within the system 100, the data including information to determine a weight requirement associated with the first action and a weight capacity of the first mover 160 (e.g., the first characteristic). For example, the task manager 130 can receive information stating that the first action requires lifting a load of 100 pounds. The task manager can receive information from the first characteristic stating that the first mover 160 can carry a load 200 weighing up to 1000 pounds. Using the information, the task manager 130 can determine that the first mover 160 is configured to perform the first action.

Components of the system 100, such as the processor 110, can determine that the second mover 165 is configured to perform the second action. For example, the processor 110 can determine that the second mover 165 is configured to perform the second action based on the second characteristic. For example, the task manager 130 can receive data from at least one of the database 120, the database 125, or another component within the system 100, the data including information to determine a speed requirement associated with the second action and a speed capability of the second mover 165 (e.g., the second characteristic). For example, the task manager 130 can receive information stating that the second action requires the second mover 165 to move at the same speed as the track 155 (e.g., 300 feet per minute). The task manager can receive information from the second characteristic stating that the second mover 165 can move at speeds up to 1000 feet per minute. Using the information, the task manager 130 can determine that the second mover 165 is configured to perform the second action.

Components of the system 100, such as the control manager 135 within the data processing system 105, can generate at least one data structure. For example, the data structure can cause the first mover 160 to perform the first action and to cause the second mover 165 to perform the second action. The first action and the second action can be associated with the task. The data structure can be a signal, a data packet, a program script, a Robot Operating System (ROS) message, a CAN Bus message, a serial communication message, among others. The data structure can include instructions or commands for performing the task. For example, the data structure can include a command that controls the first mover 160 to perform the first action. The data structure can include a command that controls the second mover 165 to perform the second action.

For example, the control manager 135 can determine that the movers receive the correct portion of the data structure. The control manager 135 can determine that the first portion of the data structure corresponds to the first action associated with the first mover 160. The control manager 135 can determine that the second portion of the data structure corresponds to the second action associated with the second mover 165.

Components of the system 100, such as the control manager 135, can provide the data structure to the movers. For example, the data structure can include a first portion and a second portion. The first portion of the data structure can be provided to the first mover 160. For example, the control manager 135 can provide the first mover 160 with a signal including a command to perform the first action. The first portion of the data structure can cause the first mover 160 to execute the first action. For example, the first portion of the data structure can cause the first mover 160 to move a load 200 from point A to point B. The second portion of the data structure can be provided to the second mover 165. The second portion of the data structure can cause the second mover 165 to execute the second action. For example, the second portion of the data structure can cause the second mover 165 to receive the load 200 from the first mover 160 at point B. The execution of the first portion of the data structure by the first mover 160 and the second portion of the data structure by the second mover 165 can cause the first mover 160 and the second mover 165 to perform the task. The first action performed by the first mover 160 and the second action performed by the second mover 165 can be performed at various times and locations. The data structure generated by the control manager 135 can be provided to both types of movers, which can remove the need to provide separate controls to each of the first mover 160 and the second mover 165 to execute the task.

Components of the system 100, such as the control manager 135 within the data processing system 105, can provide the data structure to the movers based on the mover type. For example, the control manager 135 can determine that the first mover 160 is of the first category of movers and is controlled with a high-level controller. In this instance, the control manager 135 can transmit the first portion of the data structure to the high-level controller of the first mover 160. Additionally, the connection formed between the data processing system 105 and the high-level controller of the first mover 160 allows for the data processing system 105 to receive feedback from the first mover 160. The feedback can include status of the first action of the task, any issues that the first mover 160 has encountered, or any other feedback from the first mover 160. As such, the data processing system 105 can receive continuous input from the first mover 160.

The control manager 135 within data processing system 105 can determine that the second mover 165 is of the second category of movers and operates based on local motion planning. In this instance, the control manager 135 can transmit the second portion of the data structure directly to the second mover 165. Additionally, the connection formed between the data processing system 105 and the second mover 165 allows for the data processing system 105 to receive feedback from the second mover 165. The feedback can include status of the second action of the task, any issues that the second mover 165 has encountered, or any other feedback from the second mover 165. As such, the data processing system 105 can receive continuous input from the second mover 165.

The data processing system 105 can use the feedback from the first mover 160 and the second mover 165 to ensure that the task is being performed accurately. For example, the first mover 160 can be moving along the track 155 carrying a load 200. The second mover 165 can be controlled to mover alongside the track 155 next to the first mover 160 to prepare to receive the load 200 at the end of the track 155. In order to ensure that the second mover 165 is moving precisely with the track 155 and the first mover 160, the data processing system 105 can communicate with both the first mover 160 and the second mover 165 to verify that the movers are operating at the desired speed and desired location. If the data processing system 105 determines that the movers are not moving precisely as desired, it can update the control to at least one of the first mover 160 or the second mover 165 to modify the action being performed.

The system 100 can implement a centralized axis object system to control the movers. For example, the first movers 160 of the system can operate on a Common Industrial Protocol (CIP) motion system. In order to facilitate communication between the first movers 160 in the CIP motion system and the second movers 165, the CIP motion system is modified to include an additional axis that is fitted to control the second movers 165. As such, the system 100 can control multiple modalities through the same control system, such as the data processing system 105. The CIP motion system can be contained within the data processing system 105.

The task can be or include a load transfer operation. For example, the load transfer operation can be an operation that requires the movement of a load from point A to point B, or from one mover to another mover. The payload manager 140, within the data processing system 105, can provide the first portion of the data structure to the first mover 160 to execute the first action associated with the load transfer operation. For example, the first action can be a transfer operation to transfer the load 200 to the second mover 165. The payload manager 140 can provide the second portion of the data structure to the second mover 165 to execute the second action associated with the load transfer operation. For example, the second action can be an operation for the second mover 165 to receive the load from the first mover 165.

The first action and the second action can be performed at time intervals that do not overlap. The processor 110 can provide the first portion of the data structure to the first mover 160 to execute the first action during a first time interval. The processor 110 can provide the second portion of the data structure to the second mover 165 to execute the second action during a second time interval. The first time interval and the second time interval can be timed such that they do not overlap. For example, the processor 110 can cause the second mover 165 to initiate execution of the second action sixty seconds after the first mover 160 initiates execution of the first action, in the case that the first action is completed within sixty seconds. For example, the processor 110 can cause the second mover 165 to initiate execution of the second action sixty seconds after the first mover 160 completes the first action.

The first action and the second action can be performed at time intervals that at least partially overlap. The processor 110 can provide the first portion of the data structure to the first mover 160 to execute the first action during a first time interval. The processor 110 can provide the second portion of the data structure to the second mover 165 during a second time interval. The first time interval and the second time interval can be timed such that they at least partially overlap. For example, the processor 110 can cause both the first mover 160 to initiate execution of the first action and the second mover 165 to initiate execution of the second action at the exact same time. In addition to initiating execution of the first action and the second action at the same time, the first action and the second action can be completed at the same time (e.g., in an optimized coordinated load transfer). The processor 110 can cause the first mover 160 to initiate execution of the first action when the second mover 165 has completed half of the second action. The partial overlap of the first time interval and the second time interval may be any other time period of overlap.

The first action and the second action can be executed at various locations. For example, the processor 110 can provide the first portion of the data structure to execute the first action. The first action can be executed at a first location during a time interval. The processor 110 can provide the second portion of the data structure to execute the second action. The second action can be executed at a second location during the time interval. The first location and the second location can be within a maximum distance from each other. For example, the first location and the second location can be less than six feet apart. The maximum distance can be a higher or lower distance.

FIG. 2 depicts an example of system 100 to control movers. The system 100 can include at least one track 155, at least one first mover 160, and at least one second mover 165. The track 155 can be an ICT track. The track 155 can be various sizes, lengths, and shapes. For example, the track 155 can be an elliptical path, a circular path, a straight path, a closed loop with multiple straight paths, among others. The track 155 can be installed in different orientations, such as sloped or vertical, and include different shaped elements including, but not limited to, straight segments, inward bends, outward bends, up slopes, down slopes and various combinations thereof. The width of the track 155 can be greater in either horizontal or vertical direction according to application requirements. The track 155 can support the first movers 160 that are movable along the track 155. For example, the first movers 160 can travel along the track 155 and take various orientations according to the configuration of the track 155. The second movers 165 can operate next to or nearby the track 155. For example, the second movers 165 can move around the floor next to the track 155 and in between tracks 155. At least one of the movers, such as one of the second movers 165, can include an industrial robot. For example, the second mover 165 can include a robotic arm 205 to facilitate grabbing a load 200 from the first mover 160.

As shown in FIG. 2, among others, the system 100 can include one or more loads 200. For example, the first mover 160 and the second mover 165 can be instructed to perform a load transfer task. The first mover 160, carrying the load 200, can receive an action, from a component of the system 100 such as the payload manager 140, to carry the load 200 along the track 155 and stop at a first location. The second mover 165 can receive an action, from a component of the system 100 such as the payload manager 140, to lift the load 200 onto a surface of the second mover 165 at the first location.

The first movers 160 and the second movers 165 can be instructed to perform the same task repeatedly. For example, the track 155 can include multiple first movers 160. Each of the multiple first movers 160 can receive instructions to move a load 200 to the first location. The second mover 165 can receive instructions to receive the load 200 from the first mover 160 that arrives at the first location. The second mover 165 can be instructed to continue the action every time a subsequent first mover 160 arrives at the first location with a load 200. For example, when the second mover 165 receives a load 200, the second mover can immediately transfer the load 200 to a second location to prepare for the subsequent load 200. The second location can be a pallet, a shelf, a truck bed, among others. The first movers 160 can be instructed to continue movement around the track 155 to approach a second location to receive a new load 200 (not shown). As such, the load transfer operation as shown in FIG. 2 can be performed repeatedly.

The system 100 can control the second movers 165 on an on-demand basis. For example, the data processing system 105 can control the first movers 160 on the track to move the loads 200 at a predetermined speed and control a second mover 165 to retrieve the loads 200 as each first mover 160 approaches. After each load 200 retrieved by the second mover 165, the second mover 165 can also be controlled to place the load 200 in a new location, such as a shelf or a pallet. In the case that an additional number of first movers 160 are placed on the track 155 with additional loads, the data processing system 105 can retrieve an additional second mover 165 to assist with retrieving the loads 200 from the first movers 160. The additional second mover 165 can automatically link with the control scheme of the first movers 160 to form a centralized communication between the movers in the system 100. The additional second mover 165 can be controlled to assist with the task as needed, and coordination between the additional second mover 165 and the first movers 160 can be terminated when the requirement for the additional second mover 165 has ended.

The system 100 can control the first movers 160 on an on-demand basis. For example, the track 155 can be a track that extends in a straight line from point A to point B. In one instance, the track can contain 30 first movers 160 to move loads from point A to point B. For example, the data processing system 105 can communicate with the 30 first movers 165 to continuously travel between point A and point B on the track 155 to continuously pick up and drop off loads 200. There can be a need for an additional first mover 165 to join the track 155 for a limited period of time. For example, a load 200 can be received at point A that must be transported to point B, but none of the 30 first movers 165 currently on the track 155 are able to carry the weight of the load 200 (the load 200 is heavier than the other loads 200 being transported on the track 155). In order to successfully move the load 200, the data processing system 105 can control an additional first mover 165 with different weight characteristics to enter the system 100 to move the load 200. When the additional first mover 165 has completed the action, the data processing system 105 can remove it from the system 100.

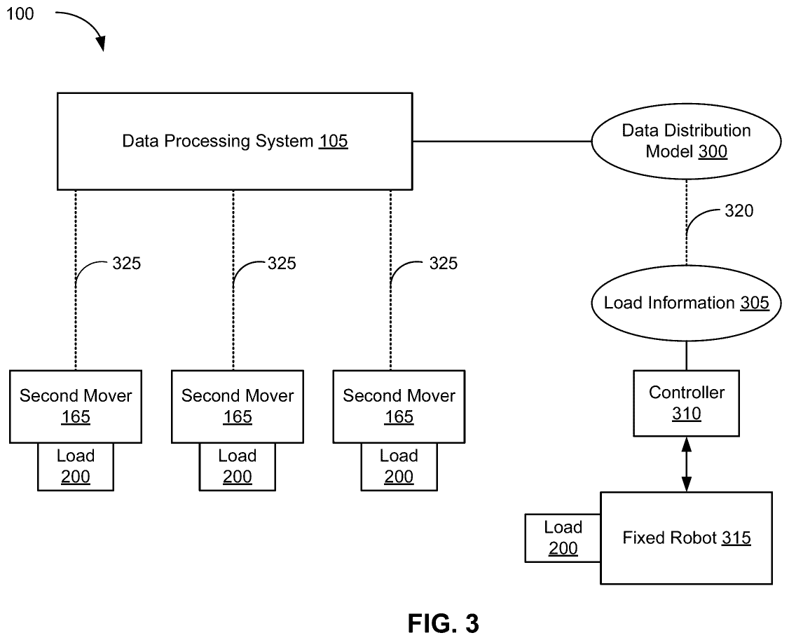

FIG. 3 depicts an example system 100 to control movers. For example, one or more components of the system 100, such as the processor 110 or the memory 115 within the data processing system 105, can facilitate communication between movers to perform a task.

A data processing system 105 can communicate between multiple types of movers to perform a task. For example, the data processing system 105 can facilitate communication between a fixed robot 315 and a plurality of second movers 165 to perform a load transfer task. The load 200 can be a pallet that contains multiple items to be unloaded. The fixed robot 315 can include at least one of a fixed robotic arm, a fixed conveyer robot, a delta robot, or a gantry robot, among others.

The data processing system 105 can verify that the correct type of movers are present before transmitting the task to the movers. For example, the data processing system 105 executing the load transfer task can require at least one robotic arm (e.g., fixed robot 315) and at least one AMR (e.g., second mover 165). An input from a user on the computing device 145 can be received by the data processing system 105, the input an indication to the data processing system 105 that the fixed robot 315 is classified as a robotic arm and that the second mover 165 is classified as an AMR. The data processing system 105 can then run a verification process to confirm that the classification of the movers provided by the computing device 145 are correct. For example, the data processing system 105 can retrieve one or more characteristics of the movers to verify the classification of the movers. The data processing system 105 can retrieve the characteristics from at least one of the database 120, the database 125, or any other component within system 100. The characteristics can be used to confirm the classification of the movers. In the event that the classification of movers retrieved from the computing device 145 is not correct, the data processing system 105 can locate a different mover to perform the task. For example, the data processing system 105 can transmit a signal to the computing device 145 to request identification of a new mover from the user. For example, the data processing system 105 can determine a new mover based on information stored within the database 120, database 125, or any another component within system 100.

The data processing system 105 can also verify that the movers can be synchronized. For example, before transmitting the task to the movers, the data processing system 105 can run a verification process to determine that the fixed robot 315 and the second mover 165 have matching capabilities to perform the task together. In some instances, both the fixed robot 315 and the second mover 165 can be capable of performing their individual assigned actions relating to the task, but the movers may not be configured to perform the task together. Thus, the data processing system 105 can verify that the movers can be synchronized together. The data processing system 105 can retrieve information from the database 120, database 125, or any other component of the system 100 regarding the capabilities of both the fixed robot 315 and the second mover 165 to determine that they are able to synchronize. For example, the data processing system 105 can verify that the movers can be in the desired location at the exact same time to perform their respective actions. For example, in a load transfer task that requires the fixed robot 315 to grab a load 200 directly from the second mover 165, the data processing system 105 can determine that the second mover 165 can communicate with the fixed robot 315 so that the second mover releases the load 200 at the exact same time and location that the fixed robot 315 grabs the load 200.

A component of the system 100, such as the task manager 130, can perform further verification that the correct mover is present at the location of the task. For example, the task manager 130 can transmit a control to a second mover 165 to move to point B to perform an action related to the task. When a second mover 165 has arrives at point B, the task manager 130 can communicate with that second mover 165 to verify that it is the exact second mover 165 that was commanded to arrive at point B. In the case that the second mover 165 at point B is not the intended second mover 165, the task manager 130 or the control manager 135 can transmit a command to the unwanted second mover 165 to relocate.

Some of the movers can be selected based on location within the environment. For example, a track-based environment can include a first robot, such as the fixed robot 315. The data processing system 105 can determine that the load transfer task requires the fixed robot 315 and a second mover 165. The data processing system 105 can communicate with the second movers 165 within a threshold distance from the fixed robot 315 to select a second mover 165 for the task. For example, the data processing system 105 can search for a second mover 165 that is within 100 feet from the first mover, or any other distance. The data processing system 105 can select the second mover 165 that is in closest proximity to the load 200 to be transferred.

The data processing system 105 can select a second mover 165 within the environment based on what the second mover 165 is carrying. For example, the data processing system 105 can determine that a second mover 165 is currently carrying a load 200 that is needed for the load transfer operation. In that case, the data processing system 105 can select that second mover 165 for the load transfer operation.

Referring to FIG. 2, among others, the load transfer task can include unloading first movers 160 from a track 155, where the first movers are carrying a load 200 on the track 155. In this example, the data processing system 105 can call upon a second mover 165 in the nearby environment to receive the load 200 from the first mover 160. After determining a potential second mover 165 to perform the action of receiving the load 200, the data processing system 105 can determine if the second mover 165 is carrying any type of load 200. If the second mover 165 is not carrying anything, the data processing system 105 can proceed with the remaining verification requirements and subsequently select the second mover 165 for the task. If the second mover 165 is carrying a load 200 and is unable to receive the load 200 from the first mover 165, the data processing system 105 can select another of the second movers 165 in the environment.

The system 100 can maintain control of the movers within a threshold distance from the system 100. For example, the system 100 can control some or all of the movers in the environment present within 1000 feet of the data processing system 105. The system 100 can receive a new mover. For example, a second mover 165 operating in a further area of the environment can enter into the 1000-foot area controlled by the system 100. Upon entering the 1000-foot area, the data processing system 105 can send a control to the second mover 165 to have the second mover 165 controlled by the system 100 of the area (e.g., a CIP motion system). The controls transmitted to the second mover 165, by the data processing system 105, can override the controls that were originally transmitted to the second mover 165 in the further area.

Referring to FIG. 3, among others, the system 100 can control the fixed robot 315 to unload a first pallet (e.g., load 200) that is stationed nearby the fixed robot 315. For example, the data processing system 105 can provide a first action to the fixed robot 315 to unload the pallet (e.g., load 200). To transmit the first action to the fixed robot 315, the data processing system 105 can connect to the controller of the fixed robot 315, controller 310. The system 100 can include a data distribution model 300. The data distribution model 300 can connect to the controller 310 to retrieve information about the fixed robot 315. For example, the data distribution model 300 can determine a weight, battery health, or any other characteristic of the fixed robot 315. The data processing system 105 can request and obtain information from the data distribution model 300 to validate that the fixed robot 315 is equipped to perform the first action associated with the load transfer task (e.g., unloading the load 200). Upon verification that the fixed robot 315 is equipped to perform the first action associated with the load transfer task, the data processing system 105 can transmit a signal 320 to the controller 310 of the fixed robot 315 to control the fixed robot 315 to execute the first action. When the pallet (e.g., load 200) has been completely unloaded, the fixed robot 315 can send load information 305, by the controller 310, to the data processing system 105 to alert the system 100 that the pallet has been emptied.

The system 100 can control the second movers 165 to transfer additional pallets (e.g., loads 200) to the fixed robot 315. For example, the data processing system 105 can provide a second action to the second movers 165 to move loads 200 near the fixed robot 315. The second movers 165 can be autonomous movers that do not require an independent controller. In this case, to transmit the second action to the second mover 165, the data processing system 105 can directly connect to the second mover 165 and transmit a signal 325 to control the second mover 165 to execute the second action. Before transmitting the signal 325 to the second mover 165, the data processing system 105 can verify that the second mover 165 is equipped to perform the second action. For example, the data processing system 105 can determine a characteristic relating to the second mover 165 to verify that the second mover 165 is equipped to perform the second action. The data processing system 105 can send the second action to an alternative second mover 165 if it is determined that the second mover 165 is not configured to execute the second action. The data processing system 105 can also proceed with sending the second action to the second mover 165 if it is determined that the second mover 165 is not configured to execute the second action. For example, the second mover 165 can still execute the second action if there are not any other second movers 165 present to complete the second action.

The data processing system 105 can facilitate communication between the fixed robot 315 and the second mover 165 during the duration of the load transfer operation. For example, the fixed robot can unload the pallet (e.g., load 200). When the fixed robot 315 detects that the pallet has become empty, the fixed robot 315, via the controller 310, can send load information 305 to the data processing system 105 to indicate that the pallet is empty. Upon receiving the load information 305, the data processing system 105 can transfer a signal 325 to control the second mover 165 to transfer a pallet to the fixed robot 315.

The data processing system 105 can include a communication mechanism that will allow the data processing system 105 to communicate with the types of movers involved in the task. In this example, the communication mechanism can allow the data processing system 105 to facilitate communication between the fixed robot 315 and the second movers 165. For example, the communication mechanism can include at least one of a publish-subscribe, service request/response, and other actions between the categories of movers.

The data processing system 105 can control more than two movers to perform the task. For example, the processor 110, or any other component within the data processing system 105, can execute the task to two second movers 165 and the fixed robot 315. The data processing system 105 can transmit a signal 325 containing a first action to a first of the second movers 165 to transfer a load 200 from point A to point B (not shown). The data processing system 105 can transmit a signal 325 containing a second action to a second of the second movers 165 to receive the load 200 from the point B (the first second mover 165) and transfer the load 200 to the fixed robot 315. An input from the computing device 145 can contain instructions for the task to include a specific number of movers. Additionally, the data processing system 105 can retrieve information on the task from the database 120, database 125, or any other component of the system 100 to determine the best configuration for the task to be performed.

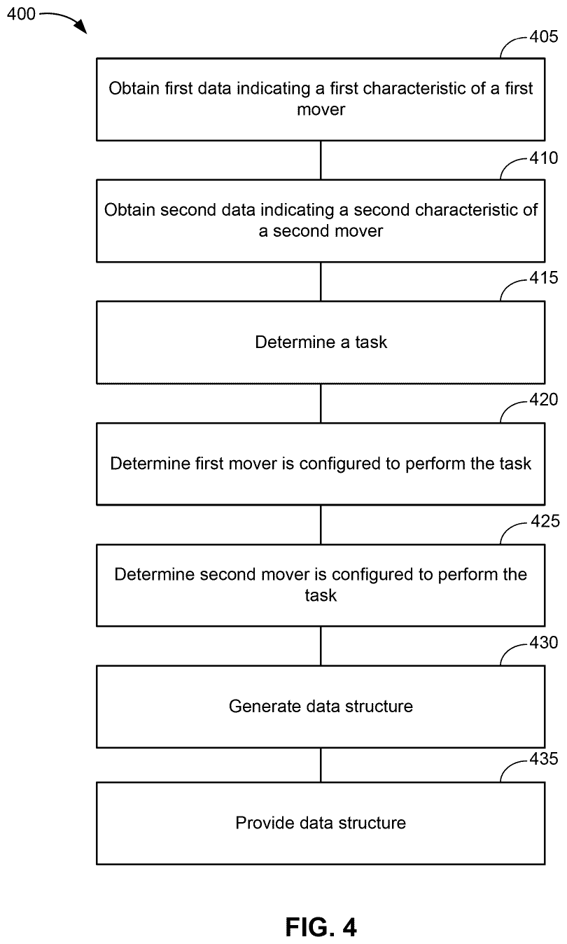

FIG. 4 depicts a method 400 of controlling movers. The method can include acts 405-435. At act 405, the method 400 can include obtaining first data indicating a first characteristic of a first mover 160. At act 410, the method 400 can include obtaining second data indicating a second characteristic of a second mover 165. At act 415, the method 400 can include determining a task. At act 420, the method 400 can include determining that the first mover 160 is configured to perform the task. At act 425, the method 400 can include determining that the second mover 165 is configured to perform the task. At act 430, the method 400 can include generating a data structure. At act 435, the method 400 can include providing the data structure.

The method 400 can include obtaining first data indicating a first characteristic of a first mover 160 (act 405). For example, the one or more processors 110 can obtain, from a database (e.g., database 120 or 125), first data indicating a first characteristic of a first mover 160 of a first category of movers. The first category of movers can include a plurality of track-based movers. For example, the first category of movers can include independent cart technology (ICT)-based movers, conveyer-based movers, linear motor movers, independent cart technology (ICT)-based movers using linear synchronous motor (LSM) technology, or any other track-based movers.

The method 400 can include obtaining second data indicating a second characteristic of a second mover 165 (act 410). For example, the one or more processors 110 can obtain second data indicating a second characteristic of a second mover 165 of a second category of movers. The second data can be obtained from a database (e.g., database 120 or 125). The second data can be obtained from the same database from the first data or obtained from a different database from the first data. The second category of movers can include a plurality of non-track-based movers. For example, the second category of movers can include autonomous mobile robots (AMR), automated guided vehicles (AGV), automated guided vehicles (AGV) using linear synchronous motor (LSM) technology, or any other non-track-based movers.

The method 400 can include determining a task (act 415). For example, the one or more processors 110 can determine a task that includes at least a first action associated with the first mover 160 and a second action associated with the second mover 165. The one or more processors 110 can retrieve data from the database 120, the database 125, or any other components of the system 100 that contain information regarding the task that needs to be executed in the environment. The first action or the second action can include, by way of example, a load transfer action, a speed action, an acceleration action, a deceleration action, an unload action, a load adjustment action, a queueing action, an obstacle avoidance action, or a lift action.

The method 400 can include determining that the first mover 160 is configured to perform the task (act 420). For example, the one or more processors 110 can determine, based on the first characteristic, that the first mover 160 is configured to perform the first action. The one or more processors 110 can retrieve data from the database 120, the database 125, or any other components of the system 100 that contain information regarding at least one of the first action or the first characteristic to determine that the first mover 160 is configured to perform the task. For example, the processors 110 can retrieve information indicating that the load 200 weighs 500 pounds. The processors 110 can also retrieve information, from the first characteristic, that the first mover 160 has a weight capacity of 1000 pounds. Using the information, the processors 110 are able to determine that the first mover 160 is able to perform the first action.

The method 400 can include determining that the second mover 165 is configured to perform the task (act 425). For example, the one or more processors 110 can determine, based on the second characteristic, that the second mover 165 is configured to perform the second action. The one or more processors 110 can retrieve data from the database 120, the database 125, or any other components of the system 100 that contain information regarding at least one of the second action or the second characteristic to determine that the second mover 165 is configured to perform the task. For example, the processors 110 can retrieve information indicating that the load 200 weighs 500 pounds. The processors 110 can also retrieve information, from the second characteristic, that the second mover 165 has a weight capacity of 1000 pounds. Using the information, the processors 110 are able to determine that the second mover 165 is able to perform the second action.

The method 400 can include generating a data structure (act 430). For example, the one or more processors 110 can generate at least one data structure to cause the first mover 160 to perform the first action and to cause the second mover 165 to perform the second action. The data structure can be a code or a signal, for example, which can be transmitted to and read by both the first mover 160 and the second mover 165.

The method 400 can include providing the data structure (act 435). For example, the one or more processors 110 can provide a first portion of the at least one data structure to the first mover 160 to execute the first action and provide a second portion of the at least one data structure to the second mover 165 to execute the second action, to cause the first mover 160 and the second mover 165 to perform the task.

FIG. 5 illustrates a block diagram of an example computing system 500, also referred to as a computer system 500 or a computing device 145. The computing system 500 can include, included by, or be used to implement a data processing system 105. The computing system 500 includes at least one bus 505 or other communication component for communicating information and at least one processor 110 or processing circuit coupled to the bus 505 for processing information. The computing system 500 can also include one or more processors 110 or processing circuits coupled to the bus for processing information. The computing system 500 also includes at least one memory 115, such as a random-access memory (RAM) or other dynamic storage device, coupled to the bus 505 for storing information, and instructions to be executed by the processor 110. The memory 115 can be used for storing information during execution of instructions by the processor 110. The computing system 500 may further include at least one read only memory (ROM) 515 or other static storage device coupled to the bus 505 for storing static information and instructions for the processor 110. The ROM 515 can be included in, or be a part of, at least one of the database 120, the database 125, or the memory 115. A storage device 520, such as a solid-state device, magnetic disk or optical disk, can be coupled to the bus 505 to persistently store information and instructions. The storage device 520 can be included in, or be a part of, at least one of the database 120, the database 125, or the memory 115.

The computing system 500 may be coupled via the bus 505 to a computing device 145, such as a liquid crystal display, or active-matrix display, for displaying information to a user. An input device 530, such as a keyboard or voice interface may be coupled to the bus 505 for communicating information and commands to the processor 110. The input device 530 can include a touch screen display. The input device 530 can also include a cursor control, such as a mouse, a trackball, or cursor direction keys, for communicating direction information and command selections to the processor 110 and for controlling cursor movement on the output device 525, such as a display. The output device 525 and the input device 530 can be included in, or a part of, the computing device 145.

The processes, systems and methods described herein can be implemented by the computing system 500 in response to the processor 110 executing an arrangement of instructions contained in memory 115. Such instructions can be read into the memory 115 from another computer-readable medium, such as the storage device 520. Execution of the arrangement of instructions contained in memory 115 causes the computing system 500 to perform the illustrative processes described herein. One or more processors in a multi-processing arrangement may also be employed to execute the instructions contained in memory 115. Hard-wired circuitry can be used in place of or in combination with software instructions together with the systems and methods described herein. Systems and methods described herein are not limited to any specific combination of hardware circuitry and software.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms can cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms can indicate that insubstantial or inconsequential modifications or alterations of the subject matter described and claimed are considered to be within the scope of the disclosure as recited in the appended claims.

The term “exemplary” and variations thereof, as used herein to describe various embodiments, can indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor 110 via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The construction and arrangement of the systems and components shown in the various exemplary embodiments is illustrative only. Additionally, any element disclosed in one embodiment may be incorporated or utilized with any other embodiment disclosed herein. For example, the techniques and controls of the system of the exemplary embodiment shown in at least FIG. 2 may be incorporated in the system of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system to control multiple categories of movers in a track-based environment, comprising:
one or more processors coupled with memory to:
obtain, from a database, first data indicating a first characteristic of a first mover of a first category of movers;
obtain second data indicating a second characteristic of a second mover of a second category of movers;
determine a task, the task including a first action associated with the first mover and a second action associated with the second mover;
determine, based on the first characteristic, that the first mover is configured to perform the first action;
determine, based on the second characteristic, that the second mover is configured to perform the second action;
generate at least one data structure to cause the first mover to perform the first action and to cause the second mover to perform the second action; and
provide a first portion of the at least one data structure to the first mover to execute the first action and provide a second portion of the at least one data structure to the second mover to execute the second action, to cause the first mover and the second mover to perform the task.

2. The system of claim 1, comprising:
the first category of movers including a plurality of track-based movers; and
the second category of movers including a plurality of non-track-based movers.

3. The system of claim 1, comprising:
the track-based environment, including an independent cart technology (ICT) track.

4. The system of claim 1, comprising:
the first characteristic indicating at least one of a load capacity, a dimension, a speed, a weight, a state of health, a payload, a machine-readable identifier, or an identifier of the first mover.

5. The system of claim 1, comprising:
the second characteristic indicating at least one of a load capacity, a dimension, a speed, a weight, a state of health, a payload, a machine-readable identifier, or an identifier of the second mover.

6. The system of claim 1, comprising the one or more processors to:
obtain, from the database, the second data indicating the second characteristic of the second mover of the second category of movers.

7. The system of claim 1, wherein the database is a first database, comprising:
the one or more processors to obtain, from a second database, the second data indicating the second characteristic of the second mover of the second category of movers.

8. The system of claim 1, comprising the one or more processors to:
determine the first portion of the at least one data structure corresponds to the first action associated with the first mover; and
determine the second portion of the at least one data structure corresponds to the second action associated with the second mover.

9. The system of claim 1, comprising the one or more processors to:
provide the first portion of the at least one data structure to the first mover to execute the first action during a first time interval; and
provide the second portion of the at least one data structure to the second mover to execute the second action during a second time interval, wherein the first time interval and the second time interval do not overlap.

10. The system of claim 1, comprising the one or more processors to:
provide the first portion of the at least one data structure to the first mover to execute the first action during a first time interval; and
provide the second portion of the at least one data structure to the second mover to execute the second action during a second time interval, wherein the first time interval and the second time interval at least partially overlap.

11. The system of claim 1, comprising the one or more processors to:
provide the first portion of the at least one data structure to the first mover to execute the first action at a first location during a time interval; and
provide the second portion of the at least one data structure to the second mover to execute the second action at a second location during the time interval.

12. The system of claim 1, comprising the one or more processors to:
provide the first portion of the at least one data structure to the first mover to execute the first action at a first location during a time interval; and
provide the second portion of the at least one data structure to the second mover to execute the second action at a second location during the time interval, wherein the first location and the second location are less than six feet apart.

13. The system of claim 1, comprising:
the first action or the second action including at least one of: a load transfer action, a speed action, an acceleration action, a deceleration action, an unload action, a load adjustment action, a queueing action, an obstacle avoidance action, or a lift action.

14. The system of claim 1, wherein the task is a load transfer operation, comprising the one or more processors to:
provide the first portion of the at least one data structure to the first mover to execute the first action, wherein the first action includes a transfer operation to transfer a load to the second mover; and
provide the second portion of the at least one data structure to the second mover to execute the second action, wherein the second action includes an operation to receive the load from the first mover.

15. A method of controlling multiple categories of movers in a track-based environment, comprising:
obtaining, by one or more processors coupled with memory, from a database, first data indicating a first characteristic of a first mover of a first category of movers;
obtaining, by the one or more processors, second data indicating a second characteristic of a second mover of a second category of movers;
determining, by the one or more processors, a task, the task including a first action associated with the first mover and a second action associated with the second mover;
determining, by the one or more processors, based on the first characteristic, that the first mover is configured to perform the first action;
determining, by the one or more processors, based on the second characteristic, that the second mover is configured to perform the second action;
generating, by the one or more processors, at least one data structure to cause the first mover to perform the first action and to cause the second mover to perform the second action; and
providing, by the one or more processors, a first portion of the at least one data structure to the first mover to execute the first action and provide a second portion of the at least one data structure to the second mover to execute the second action, to cause the first mover and the second mover to perform the task.

16. The method of claim 15, comprising:
the first category of movers including a plurality of track-based movers; and
the second category of movers including a plurality of non-track-based movers.

17. The method of claim 15, comprising:
obtaining, by the one or more processors, from the database, the second data indicating the second characteristic of the second mover of the second category of movers.

18. The method of claim 15, wherein the database is a first database, comprising:
obtaining, by the one or more processors, from a second database, the second data indicating the second characteristic of the second mover of the second category of movers.

19. The method of claim 15, comprising:
determining, by the one or more processors, the first portion of the at least one data structure corresponds to the first action associated with the first mover; and
determining, by the one or more processors, the second portion of the at least one data structure corresponds to the second action associated with the second mover.

20. The method of claim 15, comprising:
providing, by the one or more processors, the first portion of the at least one data structure to the first mover to execute the first action at a first location during a time interval; and
providing, by the one or more processors, the second portion of the at least one data structure to the second mover to execute the second action at a second location during the time interval.
